(19) United States
(12) Patent Application Publication
(10) Pub. No.: US 2024/0259379 A1
(43) Pub. Date: Aug. 1, 2024

(54) USER MANAGEMENT IN A MULTI-TENANT DATA MANAGEMENT SYSTEM

(71) Applicant: Rubrik, Inc., Palo Alto, CA (US)

(72) Inventors: Hao Wu, Mountain View, CA (US); Alex Medovar, San Francisco, CA (US); Xiaoqing Tao, San Jose, CA (US); Jinshuo Zhang, San Jose, CA (US); Seungyeop Han, San Jose, CA (US); Sai Tanay Desaraju, Redwood City, CA (US); Kevin Mu, Saratoga, CA (US); Xiang Xu, Foster City, CA (US); Lokesh Jagasia, Union City, CA (US); Shrihari Kalkar, Santa Clara, CA (US); Anam Bhatia, San Jose, CA (US); Michael Wronski, Johns Creek, GA (US); Arvind Swaminathan, Bangalore (IN)

(21) Appl. No.: 18/128,191

(22) Filed: Mar. 29, 2023

(30) Foreign Application Priority Data
Jan. 27, 2023 (IN) 202341005513

(51) Int. Cl. H04L 9/40

(52) U.S. Cl. CPC H04L 63/102; H04L 63/0815; H04L 63/083

(57) ABSTRACT

Methods, systems, and devices for data management are described. A data management system may receive an indication to create a set of subtenants of a tenant. A first set of user profiles are associated with the tenant and a second set of user profiles are associated with a parent tenant of the tenant. The system may assign a first subset of the first set of user profiles to a first subtenant and assign a second subset to a second subtenant. The first subset and the second subset exclude user profiles from the second set of user profiles that are non-overlapping with the first set of user profiles. The system may update metadata corresponding to the first set of user profiles and the second set of user profiles such that the first subset has access to the first subtenant for and the second subset has access to the second subtenant.

### CROSS REFERENCE

The present application for patent claims the benefit of India Patent Application No. 202341005513 by WU et al., entitled “USER MANAGEMENT IN A MULTI-TENANT DATA MANAGEMENT SYSTEM,” filed Jan. 27, 2023, assigned to the assignee hereof, and expressly incorporated by reference herein.

### FIELD OF TECHNOLOGY

The present disclosure relates generally to data management, including techniques for user management in a multi-tenant data management system.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports user management in a multi-tenant data management system in accordance with aspects of the present disclosure.

FIG. 2 illustrates an example of a multi-tenancy system that supports user management in a multi-tenant data management system in accordance with aspects of the present disclosure.

FIG. 3 illustrates an example of a user ownership diagram in a multi-tenancy system that supports user management in a multi-tenant data management system in accordance with aspects of the present disclosure.

FIG. 4 illustrates an example of a user interface that supports user management in a multi-tenant data management system in accordance with aspects of the present disclosure.

FIG. 5 illustrates a block diagram of an apparatus that supports user management in a multi-tenant data management system in accordance with aspects of the present disclosure.

FIG. 6 illustrates a block diagram of a multi-tenant user manager that supports user management in a multi-tenant data management system in accordance with aspects of the present disclosure.

FIG. 7 illustrates a diagram of a system including a device that supports user management in a multi-tenant data management system in accordance with aspects of the present disclosure.

FIGS. 8 through 13 illustrate flowcharts showing methods that support user management in a multi-tenant data management system in accordance with aspects of the present disclosure.

### DETAILED DESCRIPTION

A multi-tenancy data management system may have resources across cloud platforms and on-premises data centers. In multi-tenant scenarios, multiple tenants (e.g., organizations or business units) may share data management resources. Further, some multi-tenant scenarios may be multi-level, with multiple hierarchical levels of tenants. For example, resources of a backup and recovery system may be shared among multiple higher-level tenants, and at least some of the higher-level tenants may be associated with one or more levels of lower-level tenants (e.g., subtenants), with resources associated with a higher-level tenant being shared by multiple subtenants of that tenant. As one such example, in an enterprise scenario, multiple business units of the same enterprise may be subtenants of the same information technology (IT) services unit, and accordingly, may share the same data management services, with the IT services unit being one of multiple higher-level tenants of a backup and recovery system and the other business units of the same enterprise being subtenants of the IT services unit. As another such example, some multi-tenancy service providers (MSPs) may be higher-level tenants of a backup and recovery system and may provide IT and data management services to multiple distinct customers (e.g., different subtenants of the MSPs).

Aspects of the present disclosure relate to assignment of users to tenants and subtenants of the data management system. For example, users of the tenant may access an application context for the data management system and associated with the tenant. The application context may be used to allow the user to create a subtenant, assign resources to the subtenant, and assign users to the subtenant. In some examples, the user may be limited to user assignment based on users that are assigned to the tenant itself. As such, the application context may enforce a hierarchical relationship when allowing user assignment to subtenants. In some cases, the tenant may be assigned users by a parent tenant or may be associated with its own single-sign-on (SSO) directory. As such, the user may assign, to a subtenant, users that are either assigned to the tenant by the parent or that are included in the SSO directory for the tenant.

In some cases, a user may be assigned to multiple tenants or subtenants. In such cases, the user may sign-in once (for a sign-on period) and switch between the various tenants using context switching. If a user is assigned to multiple subtenants/tenants, when the user logs in, the system may enforce the login procedure that is associated with a higher security setting among login procedures associated with the tenants/subtenants to which the user is assigned. Further, the user with access to multiple tenants may not be allowed to reset authentication parameters (e.g., password or two-factor authentication) via a tenant such as to prevent privilege escalations. In such cases, the user may be required to reset authentication parameters via the parent tenant context. Additionally, or alternatively, the data management system may support internet protocol (IP) address whitelisting on a tenant by tenant (or subtenant) basis. These and other techniques are described in further detail herein with respect to the figures.

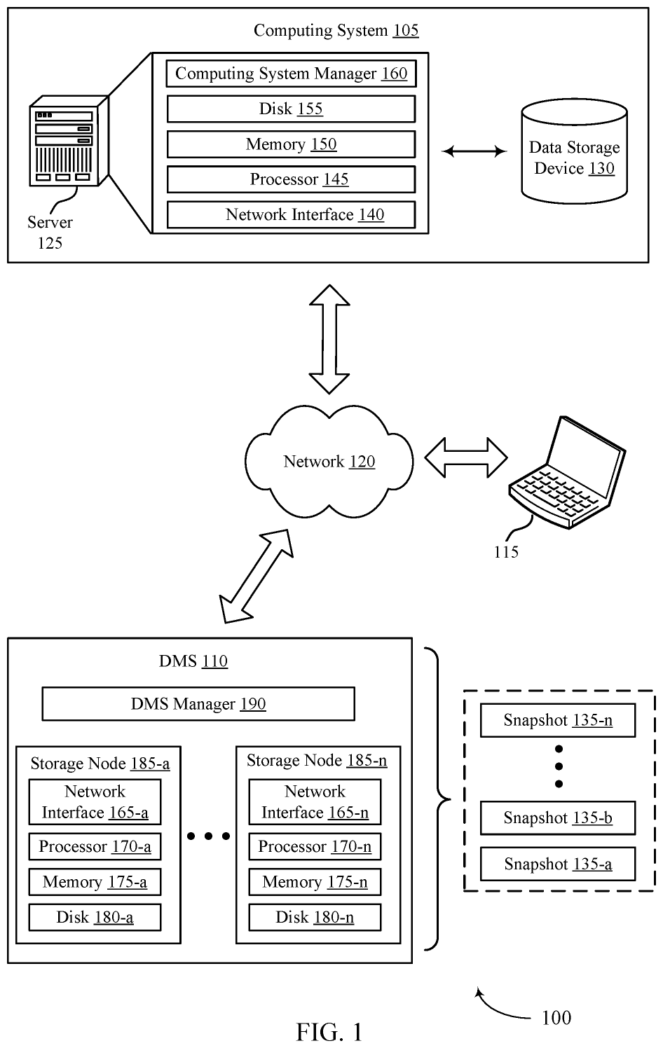

FIG. 1 illustrates an example of a computing environment 100 that supports user management in a multi-tenant data management system in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory ((ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target data sources within the computing system 105. A snapshot 135 of a data source (e.g., a virtual machine, a database, a filesystem, a virtual disk, a virtual desktop, or other type of computing system or storage system) may be a file (or set of files) that represents a state of the data source (e.g., the data thereof) as of a particular point in time. A snapshot 135 may also be used to restore (e.g., recover) the corresponding data source as of the particular point in time corresponding to the snapshot 135. A data source of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the data source as of a particular point in time. For example, a snapshot 135 may include metadata associated with (e.g., that defines a state of) some or all data blocks included in (e.g., stored by or otherwise included in) the data source. Snapshots 135 (e.g., collectively) may capture changes in the data blocks over time. Snapshots 135 generated for the target data sources within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target data source associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target data source into a frozen state (e.g., a read-only state). Setting the target data source into a frozen state may allow a point-in-time snapshot 135 of the target data source to be stored or transferred.

In some examples, the computing system 105 may generate the snapshot 135 based on the frozen state of the data source. For example, the computing system 105 may execute an agent of the DMS 110 (e.g., the agent may be software installed at and executed by one or more servers 125), and the agent may cause the computing system 105 to generate the snapshot 135 and transfer the snapshot to the DMS 110 in response to the request from the DMS 110. In some examples, the computing system manager 160 may cause the computing system 105 to transfer, to the DMS 110, data that represents the frozen state of the target data source, and the DMS 110 may generate a snapshot 135 of the target data source based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target data source that has been set into a frozen state may be written by the computing system 105 to a separate file (e.g., an update file) or other entity within the computing system 105 while the target data source is in the frozen state. After the snapshot 135 (or associated data) of the target data source has been transferred to the DMS 110, the computing system manager 160 may release the target data source from the frozen state, and any corresponding updates written to the separate file or other entity may be merged into the target data source.

In response to a restore command (e.g., from a computing device 115 or the computing system 105), the DMS 110 may restore a target version (e.g., corresponding to a particular point in time) of a data source based on a corresponding snapshot 135 of the data source. In some examples, the corresponding snapshot 135 may be used to restore the target version based on data of the data source as stored at the computing system 105 (e.g., based on information included in the corresponding snapshot 135 and other information stored at the computing system 105, the data source may be restored to its state as of the particular point in time). Additionally, or alternatively, the corresponding snapshot 135 may be used to restore the data of the target version based on data of the data source as included in one or more backup copies of the data source (e.g., file-level backup copies or image-level backup copies). Such backup copies of the data source may be generated in conjunction with or according to a separate schedule than the snapshots 135. For example, the target version of the data source may be restored based on the information in a snapshot 135 and based on information included in a backup copy of the target object generated prior to the time corresponding to the target version. Backup copies of the data source may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the data source and transfer the data of the restored data source to the computing system 105. And in some examples, the DMS 110 may transfer one or more snapshots 135 to the computing system 105, and restoration of the target version of the data source may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a data source based on a snapshot 135 corresponding to the data source (e.g., along with data included in a backup copy of the data source) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the data source for access by the computing system 105, the DMS 110, or the computing device 115.

In some examples, the DMS 110 may store different types of snapshots, including for the same data source. For example, the DMS 110 may store both base snapshots 135 and incremental snapshots 135. A base snapshot 135 may represent the entirety of the state of the corresponding data source as of a point in time corresponding to the base snapshot 135. An incremental snapshot 135 may represent the changes to the state—which may be referred to as the delta—of the corresponding data source that have occurred between an earlier or later point in time corresponding to another snapshot 135 (e.g., another base snapshot 135 or incremental snapshot 135) of the data source and the incremental snapshot 135. In some cases, some incremental snapshots 135 may be forward-incremental snapshots 135 and other incremental snapshots 135 may be reverse-incremental snapshots 135. To generate a full snapshot 135 of a data source using a forward-incremental snapshot 135, the information of the forward-incremental snapshot 135 may be combined with (e.g., applied to) the information of an earlier base snapshot 135 of the data source along with the information of any intervening forward-incremental snapshots 135, where the earlier base snapshot 135 may include a base snapshot 135 and one or more reverse-incremental or forward-incremental snapshots 135. To generate a full snapshot 135 of a data source using a reverse-incremental snapshot 135, the information of the reverse-incremental snapshot 135 may be combined with (e.g., applied to) the information of a later base snapshot 135 of the data source along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more data sources of the computing system 105, metadata for one or more data sources of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated data source within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some aspects, the DMS 110 may provide backup and recovery protection for data sources for multiple tenants. For example, multiple tenants may share data management resources (e.g., computing objects) of the DMS 110, such as the DMS manager 190 and the storage nodes 185. Further, some multi-tenant scenarios may be multi-level, with multiple hierarchical levels of tenants. For example, resources of a backup and recovery system may be shared among multiple higher-level tenants, and at least some of the higher-level tenants may be associated with one or more levels of lower-level tenants (e.g., subtenants), with resources associated with a higher-level tenant being shared by multiple subtenants of that tenant. As one such example, in an enterprise scenario, multiple business units (e.g., teams) of the same enterprise (e.g., organization) may be subtenants of the same IT services unit, and accordingly, may share the same DMS 110, with the IT services unit being one of multiple higher-level tenants of a backup and recovery system and the other business units of the same enterprise being subtenants of the IT services unit. As another such example, some MSPs may be higher-level tenants of the DMS 110 and may provide IT and data management services to multiple distinct customers (e.g., different subtenants of the MSPs).

The DMS 110 corresponding to a tenant may be accessed to create subtenants and assign backup and recovery resources to the subtenants. For example, the DMS 110 may be used to configure a set of resources for a tenant. In some examples, the resources of the tenant may include each of the storage nodes 185 such that the entirety of the resources of the DMS 110 are usable for backup and recovery for the tenant. In other cases, a portion of the resources of the DMS 110 (e.g., a subset of the storage nodes 185) may be assigned to a tenant. Additionally, or alternatively, configuration of resources may include configuration of cloud resources. After configuration of backup and recovery resources for the tenant, an administrator of the tenant may access the user interface of the DMS (e.g., a platform used for managing the DMS 110, other DMS, or cloud resources) to create one or more subtenants.

After creation of the subtenants, the administrator may assign backup and recovery resources to the subtenants. As described in further detail herein, the administrator is permitted to assign the resources that are configured for the tenant. In some examples, the administrator is prohibited from assigning, to subtenants of the tenant, resources that are not assigned to the tenant. Additionally, resources that are assigned to one subtenant may be prohibited from being assigned to another subtenant. Role based access control techniques may be used to manage resource assignment, and the access control techniques may depend on a hierarchical relationship between backup and recovery resources. Assignment of a subset of the resource configured for the tenant may include assigning logical portions of the resources, and the logical portions may include different capacities. The DMS 110 may subsequently activate a backup (or recovery) procedure for a data source associated with one of the subtenants. The backup procedure may utilize the assigned resources (e.g., subset of the resource configured for the tenant) for backing up data.

The administrator may also assign users to the tenants/subtenants, and user assignment may be managed based on a similar hierarchical relationship. For example, the administrator of a tenant may be able to assign users to a subtenant of the tenant, and the users may be selected from a set of users that are owned or assigned to the tenant. Additionally, a user may be assigned to multiple tenants of the DMS 110, and the user may be allowed to switch between tenant contexts. Additionally, the DMS 110 may enforce the login procedure with the highest security setting between multiple tenants that the user is assigned. Further, the DMS 110 may support IP address whitelisting separately for each tenant/subtenant of the DMS 110.

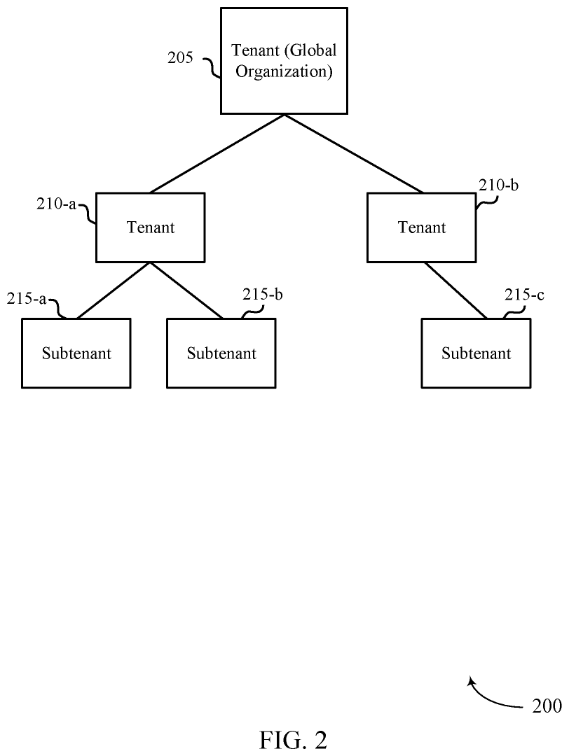

FIG. 2 illustrates an example of a multi-tenancy system 200 that supports user management in a multi-tenant data management system in accordance with aspects of the present disclosure. The multi-tenancy system 200 may implement or be implemented by aspects of the computing environment 100 described with reference to FIG. 1. For example, a DMS 110 may provide backup and recovery protection for data sources for multiple tenants and/or subtenants.

As described herein, a global organization (e.g., a tenant 205) may provide IT services, including backup and recovery protection via a DMS 110, to multiple tenants (e.g., tenant 210-a and tenant 210-b). Additionally, each tenant may further have subtenants. For example, the tenant 210-a may have a subtenant 215-a and a subtenant 215-b. For example, the tenant 205 may be the IT services unit of an organization, and the tenant 210-a and the tenant 210-b may be business units of or teams within the organization. The subtenant 215-a and the subtenant 215-b may be sub-business units or sub-teams of the business unit corresponding to the tenant 210-a (e.g., working groups within the business unit). The subtenant 215-c similarly may be a sub-business unit or sub-teams of the business unit corresponding to the tenant 210-b. As another example, the tenant 205 may be an MSP, and the tenant 210-a and the tenant 210-b may be different enterprises/customers (e.g., organizations) of the MSP. The subtenant 215-a, the subtenant 215-b, and the subtenant 215-c may be business units and/or working groups/entities/teams of the enterprises/customers corresponding to the tenant 210-a and the tenant 210-b.

In some examples, the tenant 205 corresponds to a DMS 110 that controls backup and recovery resources that are used to provide backup and recovery protection to the various tenants 210-a and subtenants 215 of the organization. An administrative user of the tenant 205 may access the DMS 110 to configure and allocate resources (e.g., computing objects) that are used to support backup and recovery for data sources associated with the various tenants and subtenants. For example, the user may access a user interface of the DMS 110 to create the tenants 210-a and 210-b and to assign the respective backup and recovery resources to the created tenants 210-a and 210-b. Assignment of resources to a tenant may include updating metadata (e.g., RBAC metadata) associated with the respective resources to indicate respective tenant or subtenant assignments. In some cases, the administrative user may assign, to a tenant or subtenant using the user interface of the DMS 110, a data source that is to be backed-up using a respective resource, a backup or recovery procedure that may be performed using the respective resource, and/or a storage capacity for the backup and recovery resource. Assignment of a data source, procedure, or capacity may include updating the metadata (e.g., RBAC metadata) associated with the backup and recovery resource (e.g., computing object) that is to be used by the tenant or subtenant.

In some cases, the administrative user may access the user interface of the DMS 110 to assign users to the tenants 210 or subtenants 215. For example, the administrative user (e.g., principal entity) of the tenant 205 may assign a second administrative user to the tenant 210-a such that the second administrative user may access the platform for backup and recovery management, as well as further subtenant creation and resource assignment, data source assignment, procedure assignment, and capacity assignment. A third administrative user may be similarly assigned to the tenant 210-b. User assignment may be restricted or controlled based on hierarchical techniques, as described herein with respect to computing object assignment. For example, a tenant 210 may assign users that are owned or inherited by the tenant 210 to subtenants of the tenant. A tenant 210 may “own” a set of users if the tenant 210 is configured with its own SSO directory. Otherwise, the tenant 210 may inherit users from a parent tenant. In some cases, the tenant inherits users in response to users being assigned to the tenant by a parent tenant. For example, the tenant 210-a may be assigned a set of users by the parent tenant 205.

In some examples, a user may be assigned to multiple tenants 210 or multiple subtenants 215. For example, a user may be assigned to both subtenant 215-a and subtenant 215-b. In such cases, the user may log in to a context associated with the subtenant 215-a or 215-b and may switch between contexts associated with the subtenants 215-a and 215-b without having to perform an additional login procedure. However, to support increased security, when a user attempts to log into one of the contexts associated with one of the subtenants 215, the DMS 110 may enforce the login procedure associated with the highest security setting among the login procedures for the subtenants 215-a and 215-b. That is, when the DMS 110 detects that a user that is logging in has access to multiple tenants or subtenants (e.g., based on metadata associated with the user), the DMS 110 may select and use the login procedure that is associated with higher security for granting the user access. The security settings may be associated with a password length, a password character requirement, a two-factor authentication requirement, a password change periodicity requirement, or a combination thereof.

Further, the DMS 110 may not allow a user that has access to multiple tenant contexts to reset authentication parameters using one of the tenant contexts. In such cases, the user may be required to use a parent tenant context to reset authentication parameters. This technique may be enforced to ensure that a user or tenant may access another tenant or subtenant without authorization. For example, if the user is assigned to both subtenant 215-a and 215-b, the subtenant 215-b cannot reset the user's authentication parameters in order to access resources of the subtenant 215-a. Rather, the user may be required to access a context associated with tenant 2010-a to reset authentication parameters. The DMS 110 may also support IP whitelisting on a tenant specific basis. Thus, each tenant 205 or 210 or subtenant 215 may be allowed, using the respective tenant contexts, to configure their own IP whitelist.

As described herein, the DMS 110 may provide for an RBAC scheme such that users associated with each tenant/subtenant may access only the computing objects assigned to the given tenant/subtenant. Accordingly, the tenants 210 and subtenants 215 may share a single DMS 110 and/or a single data management cluster without unauthorized access by any tenant 210 or subtenant 215 to computing objects or files assigned to a different tenant 210 or subtenant 215. For example, one business unit of an enterprise may not access computing objects or files assigned to a different business unit of the enterprise. As another example, one customer of an MSP may not access computing objects or files assigned to a different customer of the MSP.

As described herein, users may access a user interface associated with the DMS 110 to control various backup and recovery aspects related to a tenant 205 or 210 or subtenant 215. In some examples, the user interface may be supported by a platform or application that is used to manage multiple DMSs 110, multiple tenants 205, subtenants 215, etc. In some examples, an authorized user may access the platform or application to control backup and recovery procedures, as well as tenant or subtenant creation and assignment. Each tenant 205 or 210 or subtenant 215 may be associated with a “context” of the platform or application. An application context refers to a state of an application that allows a user to manage to control aspects of backup and recovery associated with a particular tenant 205 or 210 or subtenant 215. Thus, a user may access an application context associated with the tenant 210-a and the user may view resources, procedures, etc. that are assigned to the tenant 210-a as well as create subtenants of the tenant 210-a (e.g., subtenants 215-a and 215-b) and assign subsets of resources to the created subtenants. Thus, when discussing a user accessing a user interface of the DMS 110 herein, the user may access the application context associated with a tenant or subtenant to perform various functions and procedures described herein.

Thus, the techniques described herein support user management for a multi-tenant data management system with multi-level organization hierarchy. Such a system may include a global organization (e.g., tenant or parent tenant) as the ancestor of all other tenant organizations, and each tenant organization could have its own subtenants. For simplicity, we use tenant and subtenant in the following descriptions, but it can be generalized to any parent organization and its children organization in the context of the multi-level organization hierarchy. Such a system may be used for both enterprise MT scenarios and MSP scenarios.

In the enterprise MT scenarios, the global organization may have partial or full control over the user-to-organization assignment, and user management, and a user is likely shared across multiple organizations. For example, a global administrator assigns a group of users to both their security organization and data backup organization, and may not allow these two organizations to invite other users without the permission of the global administrator. In the MSP scenarios, the global organization may have the tenant organization to manage their own users by themselves without involving global administrators. Tenant organizations usually integrate their own user directories.

The multi-tenancy user management techniques described herein supports both scenarios with simple and unified user experience (UX) flows in account-wise user login with organization switcher, user/group listing and management, organization-level SSO identity provider integration, organization-level user authentication settings (e.g., multi-factor authentication (MFA), user account lockout, and IP whitelist). The multi-tenancy user management techniques may leverage RBAC on users and groups as RBAC resources to ensure each organization can only manage the users and groups authorized to the organization. The system may further include mechanisms to prevent potential privilege escalation in the scenarios that a user is authorized to multiple organizations. For example, an organization is not allowed to gain access to another organization by resetting authentication methods/parameters (e.g., password and/or MFA) of a user assigned to both organizations.

As described, the system allows the global organization to configure user management mode for its tenant organizations for different scenarios. In some examples, the system supports the following three modes: (1) allow a tenant organization to configure a tenant organization specific SSO directory (e.g., in MSP scenarios); (2) allow a tenant organization to inherit the SSO directory from the global organization such that the tenant may invite global organization's SSO users or groups to itself. (e.g., in enterprise MT scenarios); and (3) allow a tenant organization to use local users. The system may also introduce the concept of user directory ownership such that the UI shows the users/groups owned by the organization itself but not those owned by its descendant organizations. The organization's own users are users it controls in enterprise MT scenarios, and thus the organization views those users in a user page. Tenant organization's own users are users that the tenant manages themselves, and thus the global organization does not view.

The techniques described herein may also support organization filters in user and group listing pages such that global organization can focus on its users and groups authorized to specific organization(s). In some examples, the system may apply strict access control to prevent privilege escalations via user management. When a user has been authorized to multiple tenant organizations at the same time, only the global organization can perform authentication change related operations on this user (e.g., password reset). Thus, a tenant organization may not gain access to other organizations through logging in as such users. Further, the user login is an account-wise action across all organizations. For a user authorized to multiple organizations, the user only needs to login once into the account, and switch to different organization contexts without re-login. When switching to an organization, the fully qualified domain name (FQDN) (e.g., uniform resource locator (URL) is also switched to the organization-unique FQDN.

In some examples, for users authorized to multiple organizations, the system may enforce the strongest security settings (including MFA, account lockout, password complexity policy etc.) across organizations to which a user has been authorized. For example, a user authorized to organization A and B. If organization A enforces MFA, but organization B does not. The MFA is required to login both organization A and B for this user. In some cases, the system supports organization-level IP whitelisting, such that each organization may configure the allowed IP addresses to login into its own organization. This technique may not impact the IP whitelisting configuration of other organizations.

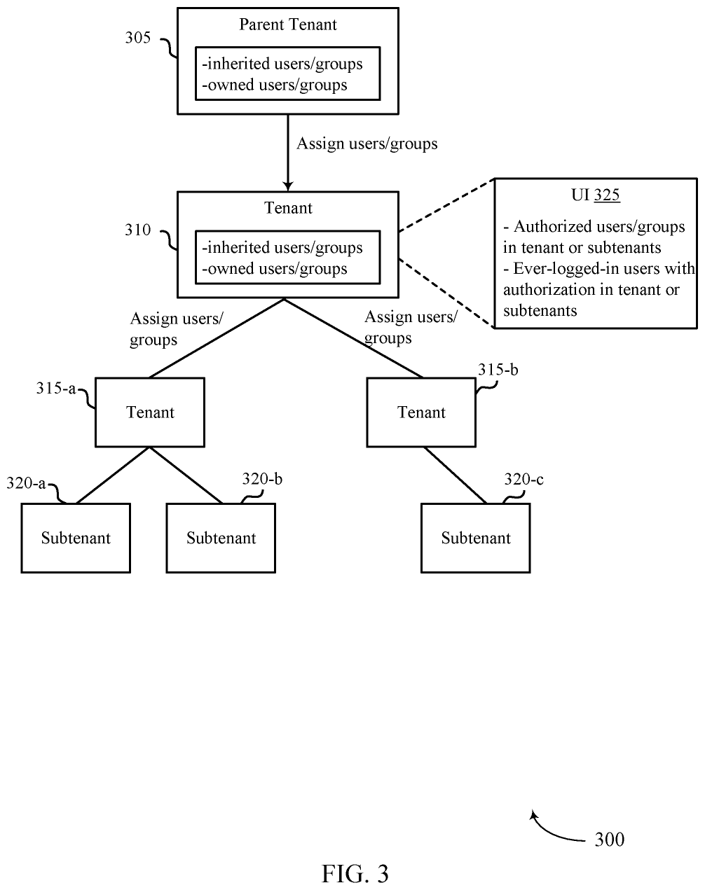

FIG. 3 illustrates an example of a multi-tenancy system 300 that supports user management in a multi-tenant data management system in accordance with aspects of the present disclosure. The multi-tenancy system 300 may implement or be implemented by aspects of the computing environment 100 described with reference to FIG. 1 and may be an example multi-tenancy system 200 of FIG. 2. For example, a DMS 110 may provide backup and recovery protection for data sources for multiple tenants and/or subtenants.

As described herein, users may access an application context of the DMS 110 to create tenants and subtenants and assign resources and users to the tenants and subtenants. In the case of user assignment, a principal entity of tenant or subtenant may assign users or groups of users that are associated with a tenant. For example, a parent tenant 305 may have inherited users/groups and/or owned users/groups. Inherited users/groups are users or groups that have been assigned to the parent tenant 305 (e.g., by the parent tenant of the tenant 305). Owned users/groups correspond to users of a SSO directory that is configured for the parent tenant 305. For example, during tenant creation or configuration, the parent tenant 305 may be configured to support its own SSO directory. When a user creates a tenant 310, which has a subtenant relationship with the parent tenant 305, the user may be able to assign users from users owned/inherited by the parent tenant 305. In some examples, the tenant 310 may be able to use its own SSO directory (e.g., owned users).

An authorized user of the tenant 310 may access the application context of the tenant via the user interface (UI) 325 to create subtenants of the tenant 310 (e.g., tenants 315-a and 315-b), assign users to the subtenants, and/or manage users. The UI 325 may display the authorized users/groups of the tenant 310 and the subtenants (e.g., tenants 315 and subtenants 320). The UI 325 may also display logged in users with authorization in the tenant 310 or the subtenants of the tenant 310. However, the UI 325 may not display users associated with the parent tenant 305 of the tenant 310 that are also not assigned to or owned by the tenant 310. As such the application context for a tenant may enforce hierarchical structures and assignments as described herein.

For example, the user of the tenant 310 may access the UI 325, enter an organization name, an organization identifier, and/or a description. Further, the UI 325 may display UI components for selecting user access configuration. For example, the UI 325 may display options for allowing the organization to create a dedicated SSO provider, allowing the organization to inherit SSO from the global organization, or allow the users to be created locally. Further, the user may activate MFA for all users in the organization via a UI component. Next, the user may assign users to the organization by assigning the organization administrator role users, the SSO groups, or both. In some examples, the system may enforce a rule that an organization is to have at least one user with the administrator role. The UI 325 may display individual users for assignment or groups for assignment.

As described herein, for users having access to multiple organizations, the global organization may make authentication related changes (e.g., reset password, reset MFA, unlock user, etc.) for these users. This technique prevents a single organization from gaining access to other organizations via simply gaining access to these users. Further, for users having access to multiple organizations, the global organization may make account-wise changes to prevent a single organization from disrupting users from other organizations. For example, currently the email notification is a per-user setting across all organizations. Further, depending on the user management mode configured for an organization, the organization may either inherit the SSO directory from its parent organization, or configure its own SSO directory. The system described herein also supports switching between organization/tenant contexts, such that the user may select the organization to login to after authentication and the user may select a new organization after the initial organization selection.

Further, each organization may configure its own organization-level MFA settings and enforce these settings to users having access to this organization. The MFA settings include whether to enforce MFA or not, MFA configuration reminder frequency, and MFA device remember period. For a user having access to multiple organizations, the system applies the strongest effective MFA settings. Additionally, each organization may configure their own IP whitelisting policy that is applied to users logging into the organization. This technique is also applicable for already-logged-in users that switch context to the organization from another organization.

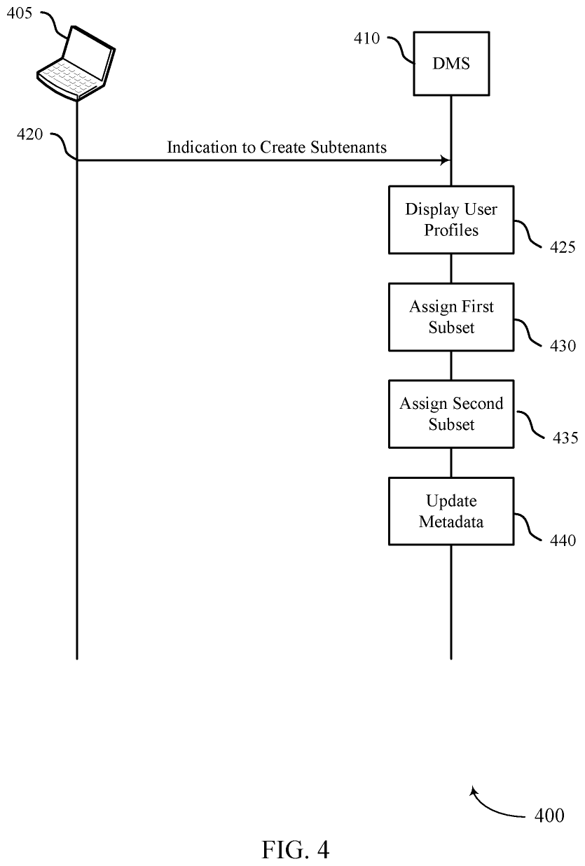

FIG. 4 illustrates an example of a process flow 400 that supports user management in a multi-tenant data management system in accordance with aspects of the present disclosure. The process flow 400 includes a user device 405 and a DMS 410, which may be an example of the DMS 110 as described with respect to FIG. 1. In the following description of the process flow 400, the operations between the user device 405 and the DMS 410 may be transmitted in a different order than the example order shown, or the operations performed may be performed in different orders or at different times. Some operations may also be omitted from the process flow 400, and other operations may be added to the process flow 400.

At 420, the DMS 410 may receive (e.g., from the user device 405) an indication to create a set of subtenants of a tenant. A first set of user profiles may be associated with the tenant and a second set of user profiles may be associated with a parent tenant of the tenant in accordance with metadata corresponding to the first set of user profiles and the second set of user profiles. For example, an administrative user of the tenant may access the application context (e.g., at the user device 405) associated with the tenant to create the set of subtenants. The user may access the application context to select and assign a subset of the set of backup and recovery resources, select and assign users (from users assigned to the tenant), assign backup and recovery procedures, and/or data sources.

At 425, the DMS 410 may display (e.g., at the application context accessed by the user device 405), the first set of user profiles for selection for assignment to the first subtenant. The second set of user profiles that are non-overlapping may be excluded from display at the user interface and from selection for assignment.

At 430, the DMS 410 may assign, in response to receiving the indication, a first subset of the first set of user profiles to a first subtenant of the set of subtenants. For example, the user may select the first subset at the user interface, and the DMS 410 may assign the selected first subset in response to receiving the selection.

At 435, the DMS 410 may assign, in response to receiving the indication, a second subset of the first set of user profiles to a second subtenant of the set of subtenants. The first subset and the second subset may exclude user profiles from the second set of user profiles that are non-overlapping with the first set of user profiles. Thus, the user may select the second subset at the user interface, and the DMS 410 may assign the selected second subset in response to receiving the selection. Further, the user may be limited from selecting profiles of the second set of user profiles that are not assigned to, inherited by, or owned by the tenant (e.g., profiles of the second set that do not overlap with the first set).

At 440, the DMS 410 may update, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant.

In some examples, the DMS 410 may assign a first user profile to both the first subtenant and the second subtenant. In such cases, the DMS 410 may receive, at the first subtenant, a login request for the first user profile. The DMS 410 may determine, in response to the login request and based on metadata (e.g., RBAC metadata) associated with the first user profile, that the first user profile is assigned to both the first subtenant and the second subtenant. The DMS 410 may enforce, based on determining that the first user profile is assigned to both the first subtenant and the second subtenant, a login procedure associated with a higher security setting between a first login procedure associated with the first subtenant and a second login procedure associated with the second subtenant. The higher security setting may be associated with a password length, a password character requirement, a two-factor authentication requirement, a password change periodicity requirement, or a combination thereof.

The DMS 410 may also receive, at a first user interface associated with the first subtenant and from the first user profile, a request to switch to the second subtenant. The DMS 410 may determine in response to receiving the request to switch and based at least in part on metadata associated with the first user profile, that the first user profile is assigned to both the first subtenant and the second subtenant. The DMS 410 may activate, based at least in part on determining that the first user profile is assigned to both the first subtenant and the second subtenant, a second user interface associated with the second subtenant. That is, the DMS 410 may switch the application context from a user interface associated with the first subtenant to a user interface associated with the second subtenant.

The DMS 410 may also receive at a first user interface associated with the first subtenant and from the first user profile, a request to reset authentication parameters associated with the first user profile. The DMS 410 may determine, in response to receiving the request to reset authentication parameters, that the first user profile is assigned to both the first subtenant and the second subtenant. The DMS 410 may deny, at the first subtenant and based at least in part on determining that the first user profile is assigned to both the first subtenant and the second subtenant, the request to reset the authentication parameters. The DMS 410 may transmit, via the first user interface, an indication that the first user profile is to request the authentication request via a user interface associated with the parent tenant.

The DMS 410 may also receive, at a user interface associated with the first subtenant, an indication of a first set of internet protocol (IP) addresses that are to be whitelisted for accessing the first subtenant. The first set of IP addresses may be different from a second set of IP addresses that are whitelisted for accessing the second subtenant. Thus, the user may access the respective application contexts for a tenant to configure IP whitelists for the corresponding tenant.

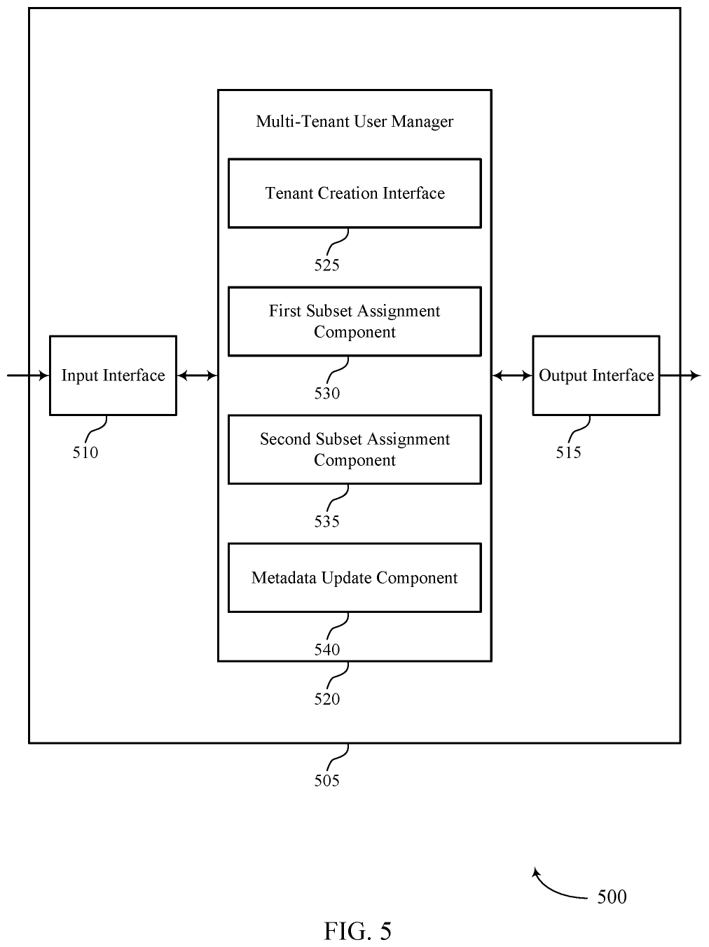

FIG. 5 illustrates a block diagram 500 of a system 505 that supports user management in a multi-tenant data management system in accordance with aspects of the present disclosure. In some examples, the system 505 may be an example of aspects of one or more components described with reference to FIG. 1, such as a DMS 110. The system 505 may include an input interface 510, an output interface 515, and a multi-tenant user manager 520. The system 505 may also include one or more processors. Each of these components may be in communication with one another (e.g., via one or more buses, communications links, communications interfaces, or any combination thereof).

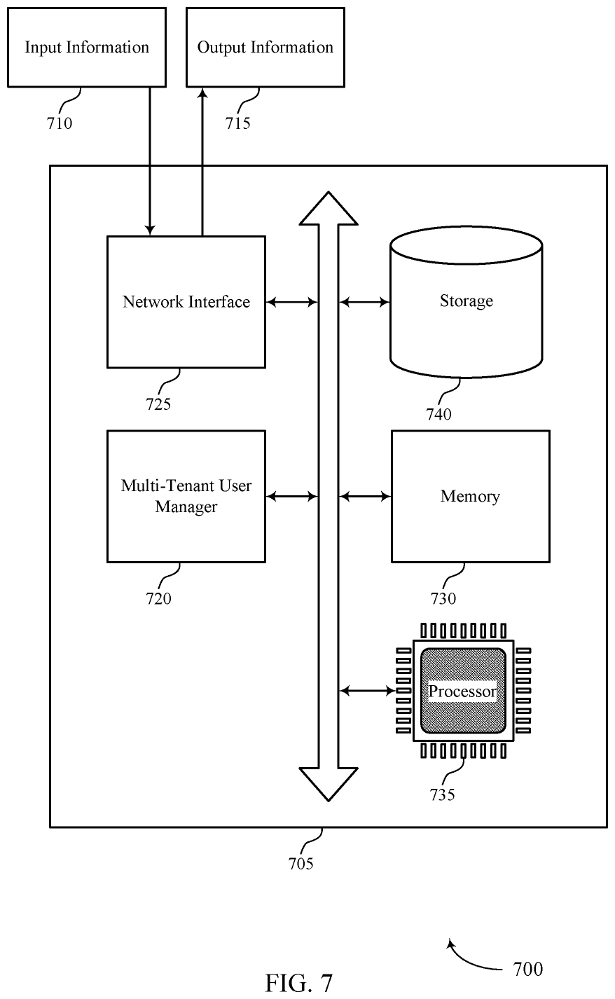

The input interface 510 may manage input signaling for the system 505. For example, the input interface 510 may receive input signaling (e.g., messages, packets, data, instructions, commands, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the multi-tenant user manager 520 to support user management in a multi-tenant data management system. In some cases, the input interface 510 may be a component of a network interface 725 as described with reference to FIG. 7.

The output interface 515 may manage output signaling for the system 505. For example, the output interface 515 may receive signaling from other components of the system 505, such as the multi-tenant user manager 520, and may transmit such output signaling corresponding to (e.g., representative of or otherwise based on) such signaling to other systems or devices. In some cases, the output interface 515 may be a component of a network interface 725 as described with reference to FIG. 7.

For example, the multi-tenant user manager 520 may include a tenant creation interface 525, a first subset assignment component 530, a second subset assignment component 535, a metadata update component 540, or any combination thereof. In some examples, the multi-tenant user manager 520, or various components thereof, may be configured to perform various operations (e.g., receiving, monitoring, transmitting) using or otherwise in cooperation with the input interface 510, the output interface 515, or both. For example, the multi-tenant user manager 520 may receive information from the input interface 510, send information to the output interface 515, or be integrated in combination with the input interface 510, the output interface 515, or both to receive information, transmit information, or perform various other operations as described herein.

The tenant creation interface 525 may be configured as or otherwise support a means for receiving, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles. The first subset assignment component 530 may be configured as or otherwise support a means for assigning, in response to receiving the indication, a first subset of the first set of user profiles to a first subtenant of the set of subtenants. The second subset assignment component 535 may be configured as or otherwise support a means for assigning, in response to receiving the indication, a second subset of the first set of user profiles to a second subtenant of the set of subtenants, where the first subset and the second subset exclude user profiles from the second set of user profiles that are non-overlapping with the first set of user profiles. The metadata update component 540 may be configured as or otherwise support a means for updating, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant.

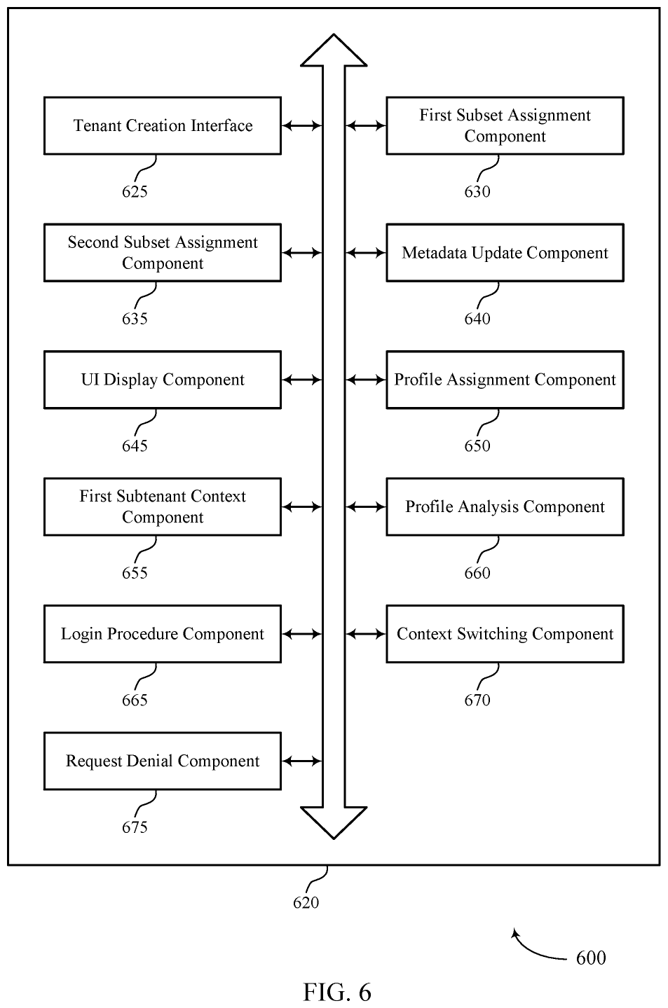

FIG. 6 illustrates a block diagram 600 of a multi-tenant user manager 620 that supports user management in a multi-tenant data management system in accordance with aspects of the present disclosure. The multi-tenant user manager 620 may be an example of aspects of a multi-tenant user manager or a multi-tenant user manager 520, or both, as described herein. The multi-tenant user manager 620, or various components thereof, may be an example of means for performing various aspects of user management in a multi-tenant data management system as described herein. For example, the multi-tenant user manager 620 may include a tenant creation interface 625, a first subset assignment component 630, a second subset assignment component 635, a metadata update component 640, a UI display component 645, a profile assignment component 650, a first subtenant context component 655, a profile analysis component 660, a login procedure component 665, a context switching component 670, a request denial component 675, or any combination thereof. Each of these components may communicate, directly or indirectly, with one another (e.g., via one or more buses, communications links, communications interfaces, or any combination thereof).

The tenant creation interface 625 may be configured as or otherwise support a means for receiving, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles. The first subset assignment component 630 may be configured as or otherwise support a means for assigning, in response to receiving the indication, a first subset of the first set of user profiles to a first subtenant of the set of subtenants. The second subset assignment component 635 may be configured as or otherwise support a means for assigning, in response to receiving the indication, a second subset of the first set of user profiles to a second subtenant of the set of subtenants, where the first subset and the second subset exclude user profiles from the second set of user profiles that are non-overlapping with the first set of user profiles. The metadata update component 640 may be configured as or otherwise support a means for updating, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant.

In some examples, the UI display component 645 may be configured as or otherwise support a means for displaying, at a user interface of the data management system, the first set of user profiles for selection for assignment to the first subtenant, where the second set of user profiles that are non-overlapping are excluded from display at the user interface and from selection for assignment.

In some examples, the first set of user profiles are associated with a single-sign-on directory configured for the tenant by an administrator of the parent tenant.

In some examples, the first set of user profiles includes a subset of the second set of user profiles, the subset of the second set of user profiles being assigned to the tenant by an administrator of the parent tenant.

In some examples, to support assigning the first subset and the second subset, the profile assignment component 650 may be configured as or otherwise support a means for assigning a first user profile to both the first subtenant and the second subtenant.

In some examples, the first subtenant context component 655 may be configured as or otherwise support a means for receiving, at the first subtenant of the data management system, a login request for the first user profile. In some examples, the profile analysis component 660 may be configured as or otherwise support a means for determining, in response to the login request and based on metadata associated with the first user profile, that the first user profile is assigned to both the first subtenant and the second subtenant. In some examples, the login procedure component 665 may be configured as or otherwise support a means for enforcing, based on determining that the first user profile is assigned to both the first subtenant and the second subtenant, a login procedure associated with a higher security setting between a first login procedure associated with the first subtenant and a second login procedure associated with the second subtenant.

In some examples, the higher security setting is associated with a password length, a password character requirement, a two-factor authentication requirement, a password change periodicity requirement, or a combination thereof.

In some examples, the first subtenant context component 655 may be configured as or otherwise support a means for receiving, at a first user interface associated with the first subtenant and from the first user profile, a request to switch to the second subtenant. In some examples, the profile analysis component 660 may be configured as or otherwise support a means for determining, in response to receiving the request to switch and based on metadata associated with the first user profile, that the first user profile is assigned to both the first subtenant and the second subtenant. In some examples, the context switching component 670 may be configured as or otherwise support a means for activating, based on determining that the first user profile is assigned to both the first subtenant and the second subtenant, a second user interface associated with the second subtenant.

In some examples, the second user interface is activated without requiring a new login procedure for the first user profile.

In some examples, the first subtenant context component 655 may be configured as or otherwise support a means for receiving, at a first user interface associated with the first subtenant and from the first user profile, a request to reset authentication parameters associated with the first user profile. In some examples, the profile analysis component 660 may be configured as or otherwise support a means for determining, in response to receiving the request to reset authentication parameters, that the first user profile is assigned to both the first subtenant and the second subtenant. In some examples, the request denial component 675 may be configured as or otherwise support a means for denying, at the first subtenant and based on determining that the first user profile is assigned to both the first subtenant and the second subtenant, the request to reset the authentication parameters. In some examples, the first subtenant context component 655 may be configured as or otherwise support a means for transmitting, via the first user interface, an indication that the first user profile is to request the authentication request via a user interface associated with the parent tenant.

In some examples, the first subtenant context component 655 may be configured as or otherwise support a means for receiving, at a user interface associated with the first subtenant, an indication of a first set of internet protocol (IP) addresses that are to be whitelisted for accessing the first subtenant, where the first set of IP addresses are different from a second set of IP addresses that are whitelisted for accessing the second subtenant.

FIG. 7 illustrates a block diagram 700 of a system 705 that supports user management in a multi-tenant data management system in accordance with aspects of the present disclosure. The system 705 may be an example of or include the components of a system 505 as described herein. The system 705 may include components for data management, including components such as a multi-tenant user manager 720, an input information 710, an output information 715, a network interface 725, a memory 730, a processor 735, and a storage 740. These components may be in electronic communication or otherwise coupled with each other (e.g., operatively, communicatively, functionally, electronically, electrically; via one or more buses, communications links, communications interfaces, or any combination thereof). Additionally, the components of the system 705 may include corresponding physical components or may be implemented as corresponding virtual components (e.g., components of one or more virtual machines). In some examples, the system 705 may be an example of aspects of one or more components described with reference to FIG. 1, such as a DMS 110.

The network interface 725 may enable the system 705 to exchange information (e.g., input information 710, output information 715, or both) with other systems or devices (not shown). For example, the network interface 725 may enable the system 705 to connect to a network (e.g., a network 120 as described herein). The network interface 725 may include one or more wireless network interfaces, one or more wired network interfaces, or any combination thereof. In some examples, the network interface 725 may be an example of may be an example of aspects of one or more components described with reference to FIG. 1, such as one or more network interfaces 165.

Memory 730 may include RAM, ROM, or both. The memory 730 may store computer-readable, computer-executable software including instructions that, when executed, cause the processor 735 to perform various functions described herein. In some cases, the memory 730 may contain, among other things, a basic input/output system (BIOS), which may control basic hardware or software operation such as the interaction with peripheral components or devices. In some cases, the memory 730 may be an example of aspects of one or more components described with reference to FIG. 1, such as one or more memories 175.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in a memory 730 to perform various functions (e.g., functions or tasks supporting user management in a multi-tenant data management system). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. In some cases, the processor 735 may be an example of aspects of one or more components described with reference to FIG. 1, such as one or more processors 170.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1, such as one or more network disks 180.

For example, the multi-tenant user manager 720 may be configured as or otherwise support a means for receiving, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles. The multi-tenant user manager 720 may be configured as or otherwise support a means for assigning, in response to receiving the indication, a first subset of the first set of user profiles to a first subtenant of the set of subtenants. The multi-tenant user manager 720 may be configured as or otherwise support a means for assigning, in response to receiving the indication, a second subset of the first set of user profiles to a second subtenant of the set of subtenants, where the first subset and the second subset exclude user profiles from the second set of user profiles that are non-overlapping with the first set of user profiles. The multi-tenant user manager 720 may be configured as or otherwise support a means for updating, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant.

By including or configuring the multi-tenant user manager 720 in accordance with examples as described herein, the system 705 may support techniques for user management in a multi-tenant data management system, which may provide one or more benefits such as, for example, for example, improved reliability, security, and more efficient use of resources, among other possibilities.

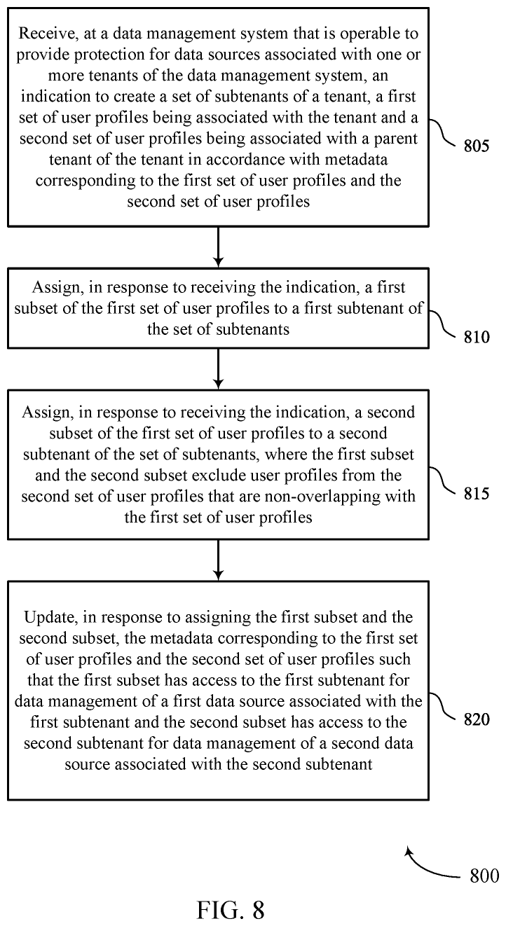

FIG. 8 illustrates a flowchart showing a method 800 that supports user management in a multi-tenant data management system in accordance with aspects of the present disclosure. The operations of the method 800 may be implemented by a DMS or its components as described herein. For example, the operations of the method 800 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 805, the method may include receiving, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles. The operations of 805 may be performed in accordance with examples as disclosed herein. In some examples, aspects of the operations of 805 may be performed by a tenant creation interface 625 as described with reference to FIG. 6.

At 810, the method may include assigning, in response to receiving the indication, a first subset of the first set of user profiles to a first subtenant of the set of subtenants. The operations of 810 may be performed in accordance with examples as disclosed herein. In some examples, aspects of the operations of 810 may be performed by a first subset assignment component 630 as described with reference to FIG. 6.

At 815, the method may include assigning, in response to receiving the indication, a second subset of the first set of user profiles to a second subtenant of the set of subtenants, where the first subset and the second subset exclude user profiles from the second set of user profiles that are non-overlapping with the first set of user profiles. The operations of 815 may be performed in accordance with examples as disclosed herein. In some examples, aspects of the operations of 815 may be performed by a second subset assignment component 635 as described with reference to FIG. 6.

At 820, the method may include updating, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant. The operations of 820 may be performed in accordance with examples as disclosed herein. In some examples, aspects of the operations of 820 may be performed by a metadata update component 640 as described with reference to FIG. 6.

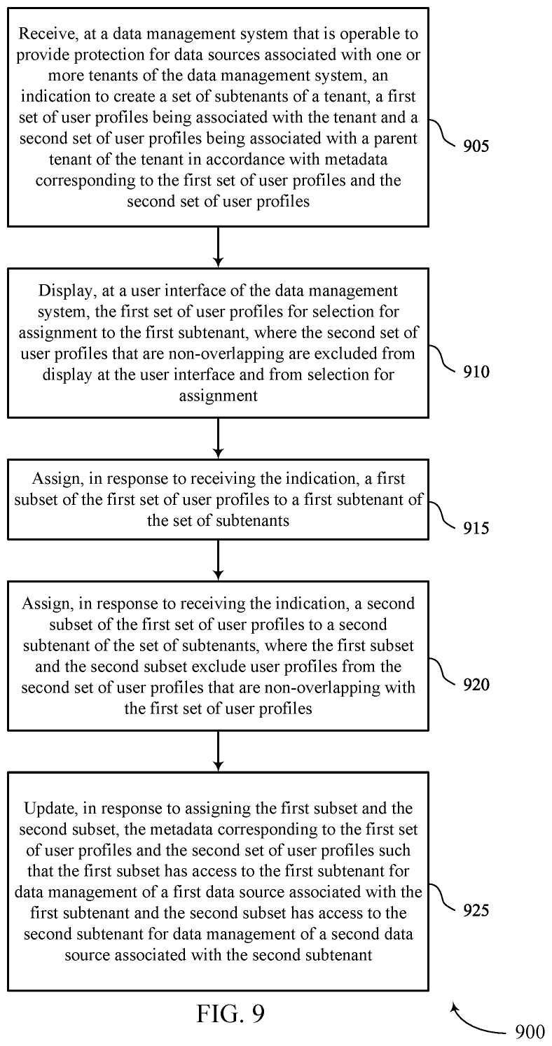

FIG. 9 illustrates a flowchart showing a method 900 that supports user management in a multi-tenant data management system in accordance with aspects of the present disclosure. The operations of the method 900 may be implemented by a DMS or its components as described herein. For example, the operations of the method 900 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 905, the method may include receiving, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles. The operations of 905 may be performed in accordance with examples as disclosed herein. In some examples, aspects of the operations of 905 may be performed by a tenant creation interface 625 as described with reference to FIG. 6.

At 910, the method may include displaying, at a user interface of the data management system, the first set of user profiles for selection for assignment to the first subtenant, where the second set of user profiles that are non-overlapping are excluded from display at the user interface and from selection for assignment. The operations of 910 may be performed in accordance with examples as disclosed herein. In some examples, aspects of the operations of 910 may be performed by a UI display component 645 as described with reference to FIG. 6.

At 915, the method may include assigning, in response to receiving the indication, a first subset of the first set of user profiles to a first subtenant of the set of subtenants. The operations of 915 may be performed in accordance with examples as disclosed herein. In some examples, aspects of the operations of 915 may be performed by a first subset assignment component 630 as described with reference to FIG. 6.

At 920, the method may include assigning, in response to receiving the indication, a second subset of the first set of user profiles to a second subtenant of the set of subtenants, where the first subset and the second subset exclude user profiles from the second set of user profiles that are non-overlapping with the first set of user profiles. The operations of 920 may be performed in accordance with examples as disclosed herein. In some examples, aspects of the operations of 920 may be performed by a second subset assignment component 635 as described with reference to FIG. 6.

At 925, the method may include updating, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant. The operations of 925 may be performed in accordance with examples as disclosed herein. In some examples, aspects of the operations of 925 may be performed by a metadata update component 640 as described with reference to FIG. 6.

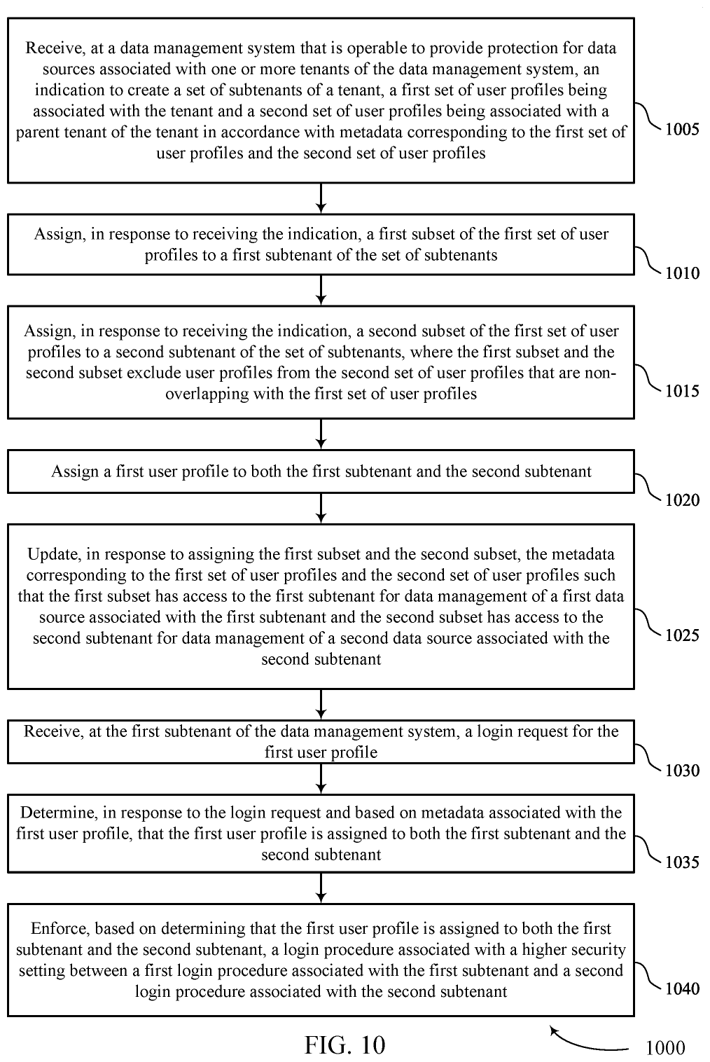

FIG. 10 illustrates a flowchart showing a method 1000 that supports user management in a multi-tenant data management system in accordance with aspects of the present disclosure. The operations of the method 1000 may be implemented by a DMS or its components as described herein. For example, the operations of the method 1000 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 1005, the method may include receiving, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles. The operations of 1005 may be performed in accordance with examples as disclosed herein. In some examples, aspects of the operations of 1005 may be performed by a tenant creation interface 625 as described with reference to FIG. 6.

At 1010, the method may include assigning, in response to receiving the indication, a first subset of the first set of user profiles to a first subtenant of the set of subtenants. The operations of 1010 may be performed in accordance with examples as disclosed herein. In some examples, aspects of the operations of 1010 may be performed by a first subset assignment component 630 as described with reference to FIG. 6.

At 1015, the method may include assigning, in response to receiving the indication, a second subset of the first set of user profiles to a second subtenant of the set of subtenants, where the first subset and the second subset exclude user profiles from the second set of user profiles that are non-overlapping with the first set of user profiles. The operations of 1015 may be performed in accordance with examples as disclosed herein. In some examples, aspects of the operations of 1015 may be performed by a second subset assignment component 635 as described with reference to FIG. 6.

At 1020, the method may include assigning a first user profile to both the first subtenant and the second subtenant. The operations of 1020 may be performed in accordance with examples as disclosed herein. In some examples, aspects of the operations of 1020 may be performed by a profile assignment component 650 as described with reference to FIG. 6.

At 1025, the method may include updating, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant. The operations of 1025 may be performed in accordance with examples as disclosed herein. In some examples, aspects of the operations of 1025 may be performed by a metadata update component 640 as described with reference to FIG. 6.

At 1030, the method may include receiving, at the first subtenant of the data management system, a login request for the first user profile. The operations of 1030 may be performed in accordance with examples as disclosed herein. In some examples, aspects of the operations of 1030 may be performed by a first subtenant context component 655 as described with reference to FIG. 6.

At 1035, the method may include determining, in response to the login request and based on metadata associated with the first user profile, that the first user profile is assigned to both the first subtenant and the second subtenant. The operations of 1035 may be performed in accordance with examples as disclosed herein. In some examples, aspects of the operations of 1035 may be performed by a profile analysis component 660 as described with reference to FIG. 6.

At 1040, the method may include enforcing, based on determining that the first user profile is assigned to both the first subtenant and the second subtenant, a login procedure associated with a higher security setting between a first login procedure associated with the first subtenant and a second login procedure associated with the second subtenant. The operations of 1040 may be performed in accordance with examples as disclosed herein. In some examples, aspects of the operations of 1040 may be performed by a login procedure component 665 as described with reference to FIG. 6.

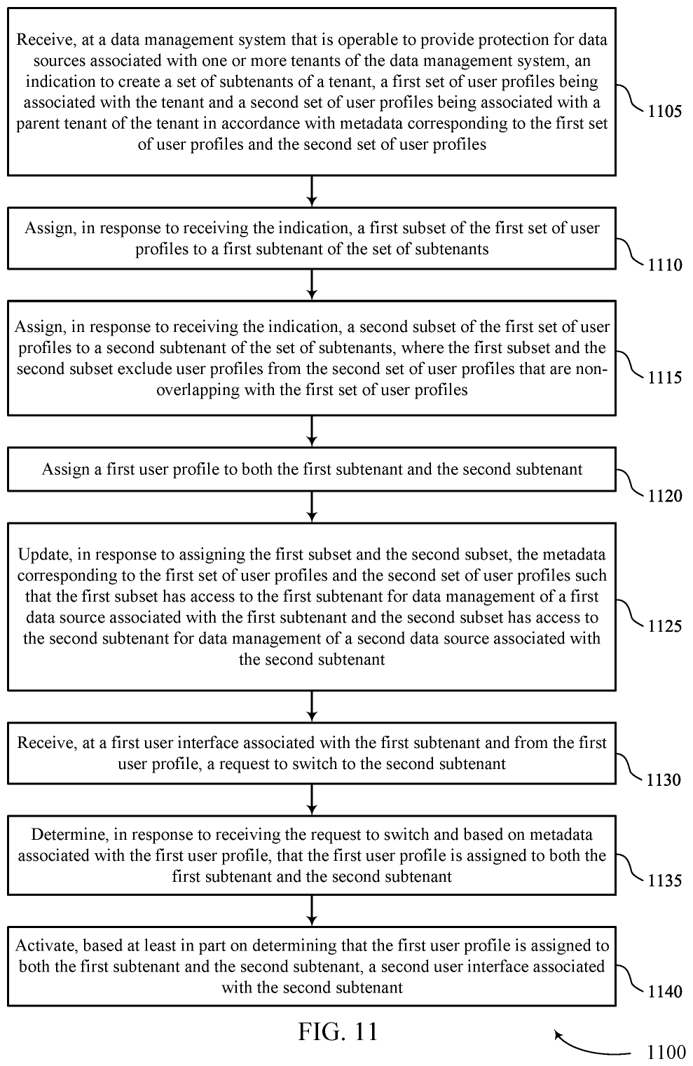

FIG. 11 illustrates a flowchart showing a method 1100 that supports user management in a multi-tenant data management system in accordance with aspects of the present disclosure. The operations of the method 1100 may be implemented by a DMS or its components as described herein. For example, the operations of the method 1100 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 1105, the method may include receiving, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles. The operations of 1105 may be performed in accordance with examples as disclosed herein. In some examples, aspects of the operations of 1105 may be performed by a tenant creation interface 625 as described with reference to FIG. 6.

At 1110, the method may include assigning, in response to receiving the indication, a first subset of the first set of user profiles to a first subtenant of the set of subtenants. The operations of 1110 may be performed in accordance with examples as disclosed herein. In some examples, aspects of the operations of 1110 may be performed by a first subset assignment component 630 as described with reference to FIG. 6.

At 1115, the method may include assigning, in response to receiving the indication, a second subset of the first set of user profiles to a second subtenant of the set of subtenants, where the first subset and the second subset exclude user profiles from the second set of user profiles that are non-overlapping with the first set of user profiles. The operations of 1115 may be performed in accordance with examples as disclosed herein. In some examples, aspects of the operations of 1115 may be performed by a second subset assignment component 635 as described with reference to FIG. 6.

At 1120, the method may include assigning a first user profile to both the first subtenant and the second subtenant. The operations of 1120 may be performed in accordance with examples as disclosed herein. In some examples, aspects of the operations of 1120 may be performed by a profile assignment component 650 as described with reference to FIG. 6.

At 1125, the method may include updating, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant. The operations of 1125 may be performed in accordance with examples as disclosed herein. In some examples, aspects of the operations of 1125 may be performed by a metadata update component 640 as described with reference to FIG. 6.

At 1130, the method may include receiving, at a first user interface associated with the first subtenant and from the first user profile, a request to switch to the second subtenant. The operations of 1130 may be performed in accordance with examples as disclosed herein. In some examples, aspects of the operations of 1130 may be performed by a first subtenant context component 655 as described with reference to FIG. 6.

At 1135, the method may include determining, in response to receiving the request to switch and based on metadata associated with the first user profile, that the first user profile is assigned to both the first subtenant and the second subtenant. The operations of 1135 may be performed in accordance with examples as disclosed herein. In some examples, aspects of the operations of 1135 may be performed by a profile analysis component 660 as described with reference to FIG. 6.

At 1140, the method may include activating, based on determining that the first user profile is assigned to both the first subtenant and the second subtenant, a second user interface associated with the second subtenant. The operations of 1140 may be performed in accordance with examples as disclosed herein. In some examples, aspects of the operations of 1140 may be performed by a context switching component 670 as described with reference to FIG. 6.

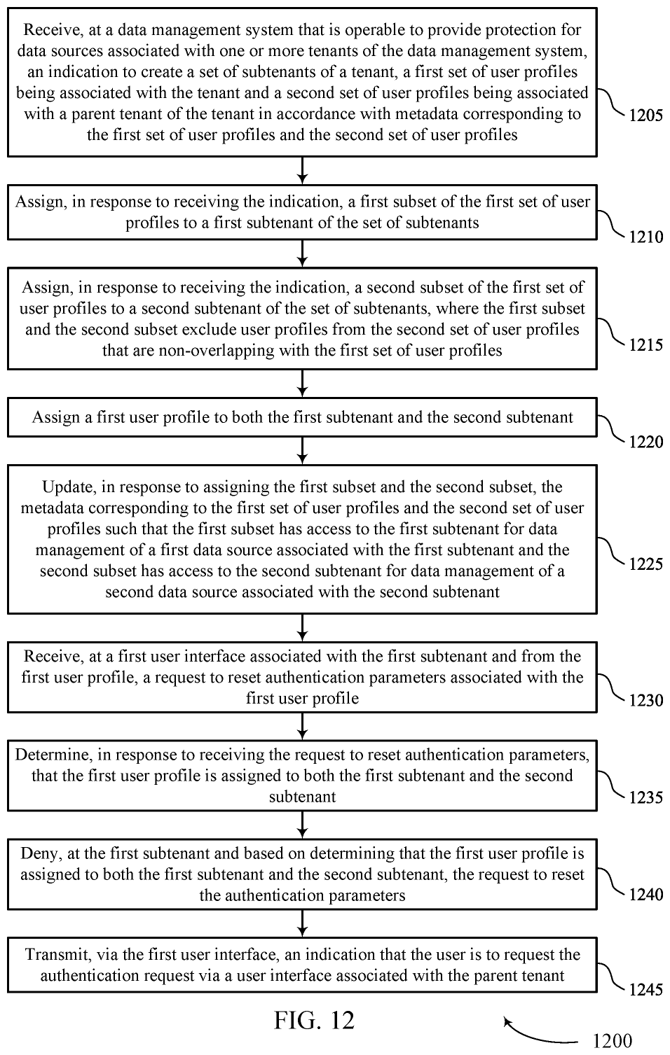

FIG. 12 illustrates a flowchart showing a method 1200 that supports user management in a multi-tenant data management system in accordance with aspects of the present disclosure. The operations of the method 1200 may be implemented by a DMS or its components as described herein. For example, the operations of the method 1200 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 1205, the method may include receiving, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles. The operations of 1205 may be performed in accordance with examples as disclosed herein. In some examples, aspects of the operations of 1205 may be performed by a tenant creation interface 625 as described with reference to FIG. 6.

At 1210, the method may include assigning, in response to receiving the indication, a first subset of the first set of user profiles to a first subtenant of the set of subtenants. The operations of 1210 may be performed in accordance with examples as disclosed herein. In some examples, aspects of the operations of 1210 may be performed by a first subset assignment component 630 as described with reference to FIG. 6.

At 1215, the method may include assigning, in response to receiving the indication, a second subset of the first set of user profiles to a second subtenant of the set of subtenants, where the first subset and the second subset exclude user profiles from the second set of user profiles that are non-overlapping with the first set of user profiles. The operations of 1215 may be performed in accordance with examples as disclosed herein. In some examples, aspects of the operations of 1215 may be performed by a second subset assignment component 635 as described with reference to FIG. 6.

At 1220, the method may include assigning a first user profile to both the first subtenant and the second subtenant. The operations of 1220 may be performed in accordance with examples as disclosed herein. In some examples, aspects of the operations of 1220 may be performed by a profile assignment component 650 as described with reference to FIG. 6.

At 1225, the method may include updating, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant. The operations of 1225 may be performed in accordance with examples as disclosed herein. In some examples, aspects of the operations of 1225 may be performed by a metadata update component 640 as described with reference to FIG. 6.

At 1230, the method may include receiving, at a first user interface associated with the first subtenant and from the first user profile, a request to reset authentication parameters associated with the first user profile. The operations of 1230 may be performed in accordance with examples as disclosed herein. In some examples, aspects of the operations of 1230 may be performed by a first subtenant context component 655 as described with reference to FIG. 6.

At 1235, the method may include determining, in response to receiving the request to reset authentication parameters, that the first user profile is assigned to both the first subtenant and the second subtenant. The operations of 1235 may be performed in accordance with examples as disclosed herein. In some examples, aspects of the operations of 1235 may be performed by a profile analysis component 660 as described with reference to FIG. 6.

At 1240, the method may include denying, at the first subtenant and based on determining that the first user profile is assigned to both the first subtenant and the second subtenant, the request to reset the authentication parameters. The operations of 1240 may be performed in accordance with examples as disclosed herein. In some examples, aspects of the operations of 1240 may be performed by a request denial component 675 as described with reference to FIG. 6.

At 1245, the method may include transmitting, via the first user interface, an indication that the first user profile is to request the authentication request via a user interface associated with the parent tenant. The operations of 1245 may be performed in accordance with examples as disclosed herein. In some examples, aspects of the operations of 1245 may be performed by a first subtenant context component 655 as described with reference to FIG. 6.

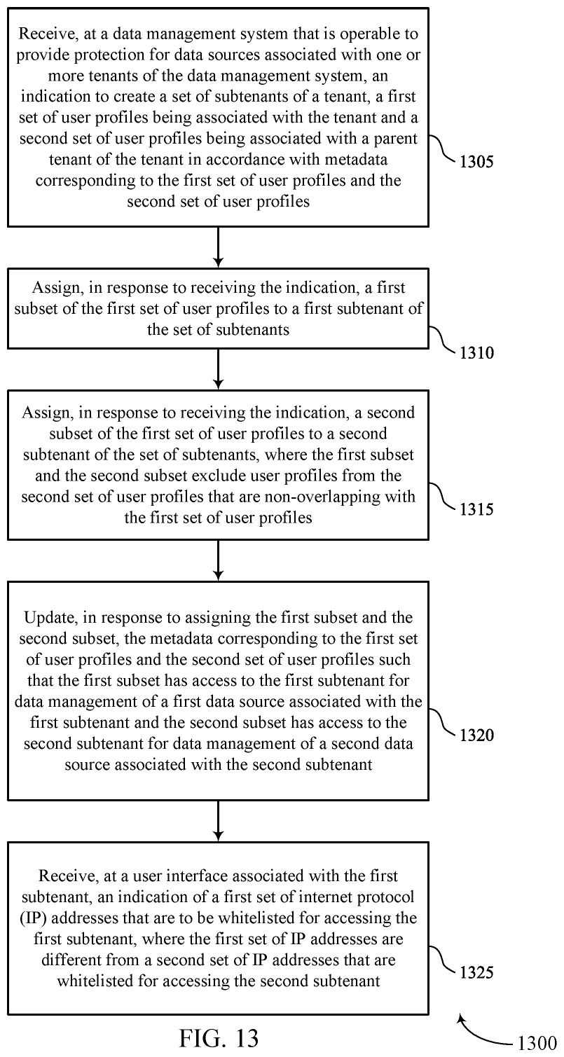

FIG. 13 illustrates a flowchart showing a method 1300 that supports user management in a multi-tenant data management system in accordance with aspects of the present disclosure. The operations of the method 1300 may be implemented by a DMS or its components as described herein. For example, the operations of the method 1300 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 1305, the method may include receiving, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles. The operations of 1305 may be performed in accordance with examples as disclosed herein. In some examples, aspects of the operations of 1305 may be performed by a tenant creation interface 625 as described with reference to FIG. 6.

At 1310, the method may include assigning, in response to receiving the indication, a first subset of the first set of user profiles to a first subtenant of the set of subtenants. The operations of 1310 may be performed in accordance with examples as disclosed herein. In some examples, aspects of the operations of 1310 may be performed by a first subset assignment component 630 as described with reference to FIG. 6.

At 1315, the method may include assigning, in response to receiving the indication, a second subset of the first set of user profiles to a second subtenant of the set of subtenants, where the first subset and the second subset exclude user profiles from the second set of user profiles that are non-overlapping with the first set of user profiles. The operations of 1315 may be performed in accordance with examples as disclosed herein. In some examples, aspects of the operations of 1315 may be performed by a second subset assignment component 635 as described with reference to FIG. 6.

At 1320, the method may include updating, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant. The operations of 1320 may be performed in accordance with examples as disclosed herein. In some examples, aspects of the operations of 1320 may be performed by a metadata update component 640 as described with reference to FIG. 6.

At 1325, the method may include receiving, at a user interface associated with the first subtenant, an indication of a first set of internet protocol (IP) addresses that are to be whitelisted for accessing the first subtenant, where the first set of IP addresses are different from a second set of IP addresses that are whitelisted for accessing the second subtenant. The operations of 1325 may be performed in accordance with examples as disclosed herein. In some examples, aspects of the operations of 1325 may be performed by a first subtenant context component 655 as described with reference to FIG. 6.

A method is described. The method may include receiving, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles, assigning, in response to receiving the indication, a first subset of the first set of user profiles to a first subtenant of the set of subtenants, assigning, in response to receiving the indication, a second subset of the first set of user profiles to a second subtenant of the set of subtenants, where the first subset and the second subset exclude user profiles from the second set of user profiles that are non-overlapping with the first set of user profiles, and updating, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant.

An apparatus is described. The apparatus may include a processor, memory coupled with the processor, and instructions stored in the memory. The instructions may be executable by the processor to cause the apparatus to receive, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles, assign, in response to receiving the indication, a first subset of the first set of user profiles to a first subtenant of the set of subtenants, assign, in response to receiving the indication, a second subset of the first set of user profiles to a second subtenant of the set of subtenants, where the first subset and the second subset exclude user profiles from the second set of user profiles that are non-overlapping with the first set of user profiles, and update, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant.

Another apparatus is described. The apparatus may include means for receiving, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles, means for assigning, in response to receiving the indication, a first subset of the first set of user profiles to a first subtenant of the set of subtenants, means for assigning, in response to receiving the indication, a second subset of the first set of user profiles to a second subtenant of the set of subtenants, where the first subset and the second subset exclude user profiles from the second set of user profiles that are non-overlapping with the first set of user profiles, and means for updating, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant.

A non-transitory computer-readable medium storing code is described. The code may include instructions executable by a processor to receive, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles, assign, in response to receiving the indication, a first subset of the first set of user profiles to a first subtenant of the set of subtenants, assign, in response to receiving the indication, a second subset of the first set of user profiles to a second subtenant of the set of subtenants, where the first subset and the second subset exclude user profiles from the second set of user profiles that are non-overlapping with the first set of user profiles, and update, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant.

Some examples of the method, apparatuses, and non-transitory computer-readable medium described herein may further include operations, features, means, or instructions for displaying, at a user interface of the data management system, the first set of user profiles for selection for assignment to the first subtenant, where the second set of user profiles that may be non-overlapping may be excluded from display at the user interface and from selection for assignment.

In some examples of the method, apparatuses, and non-transitory computer-readable medium described herein, the first set of user profiles may be associated with a single-sign-on directory configured for the tenant by an administrator of the parent tenant.

In some examples of the method, apparatuses, and non-transitory computer-readable medium described herein, the first set of user profiles includes a subset of the second set of user profiles, the subset of the second set of user profiles being assigned to the tenant by an administrator of the parent tenant.

In some examples of the method, apparatuses, and non-transitory computer-readable medium described herein, assigning the first subset and the second subset may include operations, features, means, or instructions for assigning a first user profile to both the first subtenant and the second subtenant.

Some examples of the method, apparatuses, and non-transitory computer-readable medium described herein may further include operations, features, means, or instructions for receiving, at the first subtenant of the data management system, a login request for the first user profile, determining, in response to the login request and based on metadata associated with the first user profile, that the first user profile may be assigned to both the first subtenant and the second subtenant, and enforcing, based on determining that the first user profile may be assigned to both the first subtenant and the second subtenant, a login procedure associated with a higher security setting between a first login procedure associated with the first subtenant and a second login procedure associated with the second subtenant.

In some examples of the method, apparatuses, and non-transitory computer-readable medium described herein, the higher security setting may be associated with a password length, a password character requirement, a two-factor authentication requirement, a password change periodicity requirement, or a combination thereof.

Some examples of the method, apparatuses, and non-transitory computer-readable medium described herein may further include operations, features, means, or instructions for receiving, at a first user interface associated with the first subtenant and from the first user profile, a request to switch to the second subtenant, determining, in response to receiving the request to switch and based on metadata associated with the first user profile, that the first user profile may be assigned to both the first subtenant and the second subtenant, and activating, based on determining that the first user profile may be assigned to both the first subtenant and the second subtenant, a second user interface associated with the second subtenant.

In some examples of the method, apparatuses, and non-transitory computer-readable medium described herein, the second user interface may be activated without requiring a new login procedure for the first user profile.

Some examples of the method, apparatuses, and non-transitory computer-readable medium described herein may further include operations, features, means, or instructions for receiving, at a first user interface associated with the first subtenant and from the first user profile, a request to reset authentication parameters associated with the first user profile, determining, in response to receiving the request to reset authentication parameters, that the first user profile may be assigned to both the first subtenant and the second subtenant, denying, at the first subtenant and based on determining that the first user profile may be assigned to both the first subtenant and the second subtenant, the request to reset the authentication parameters, and transmitting, via the first user interface, an indication that the first user profile is to request the authentication request via a user interface associated with the parent tenant.

Some examples of the method, apparatuses, and non-transitory computer-readable medium described herein may further include operations, features, means, or instructions for receiving, at a user interface associated with the first subtenant, an indication of a first set of internet protocol (IP) addresses that is to be whitelisted for accessing the first subtenant, where the first set of IP addresses may be different from a second set of IP addresses that may be whitelisted for accessing the second subtenant.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for data management comprising:
receiving, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles;
assigning, in response to receiving the indication, a first subset of the first set of user profiles to a first subtenant of the set of subtenants;
assigning, in response to receiving the indication, a second subset of the first set of user profiles to a second subtenant of the set of subtenants, wherein the first subset and the second subset exclude user profiles from the second set of user profiles that are non-overlapping with the first set of user profiles; and
updating, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant.

2. The method of claim 1, further comprising:
displaying, at a user interface of the data management system, the first set of user profiles for selection for assignment to the first subtenant, wherein the second set of user profiles that are non-overlapping are excluded from display at the user interface and from selection for assignment.

3. The method of claim 1, wherein the first set of user profiles are associated with a single-sign-on directory configured for the tenant by an administrator of the parent tenant.

4. The method of claim 1, wherein the first set of user profiles comprises a subset of the second set of user profiles, the subset of the second set of user profiles being assigned to the tenant by an administrator of the parent tenant.

5. The method of claim 1, wherein assigning the first subset and the second subset comprises:
assigning a first user profile to both the first subtenant and the second subtenant.

6. The method of claim 5, further comprising:
receiving, at the first subtenant of the data management system, a login request for the first user profile;
determining, in response to the login request and based at least in part on metadata associated with the first user profile, that the first user profile is assigned to both the first subtenant and the second subtenant; and
enforcing, based at least in part on determining that the first user profile is assigned to both the first subtenant and the second subtenant, a login procedure associated with a higher security setting between a first login procedure associated with the first subtenant and a second login procedure associated with the second subtenant.

7. The method of claim 6, wherein the higher security setting is associated with a password length, a password character requirement, a two-factor authentication requirement, a password change periodicity requirement, or a combination thereof.

8. The method of claim 5, further comprising:
receiving, at a first user interface associated with the first subtenant and from the first user profile, a request to switch to the second subtenant;
determining, in response to receiving the request to switch and based at least in part on metadata associated with the first user profile, that the first user profile is assigned to both the first subtenant and the second subtenant; and
activating, based at least in part on determining that the first user profile is assigned to both the first subtenant and the second subtenant, a second user interface associated with the second subtenant.

9. The method of claim 8, wherein the second user interface is activated without requiring a new login procedure for the first user profile.

10. The method of claim 5, further comprising:
receiving, at a first user interface associated with the first subtenant and from the first user profile, a request to reset authentication parameters associated with the first user profile;
determining, in response to receiving the request to reset authentication parameters, that the first user profile is assigned to both the first subtenant and the second subtenant;
denying, at the first subtenant and based at least in part on determining that the first user profile is assigned to both the first subtenant and the second subtenant, the request to reset the authentication parameters; and
transmitting, via the first user interface, an indication that the first user profile is to request the authentication request via a user interface associated with the parent tenant.

11. The method of claim 1, further comprising:
receiving, at a user interface associated with the first subtenant, an indication of a first set of internet protocol (IP) addresses that are to be whitelisted for accessing the first subtenant, wherein the first set of IP addresses are different from a second set of IP addresses that are whitelisted for accessing the second subtenant.

12. An apparatus, comprising:
a processor;
memory coupled with the processor; and
instructions stored in the memory and executable by the processor to cause the apparatus to:
receive, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles;
assign, in response to receiving the indication, a first subset of the first set of user profiles to a first subtenant of the set of subtenants;
assign, in response to receiving the indication, a second subset of the first set of user profiles to a second subtenant of the set of subtenants, wherein the first subset and the second subset exclude user profiles from the second set of user profiles that are non-overlapping with the first set of user profiles; and
update, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant.

13. The apparatus of claim 12, wherein the instructions are further executable by the processor to cause the apparatus to:
display, at a user interface of the data management system, the first set of user profiles for selection for assignment to the first subtenant, wherein the second set of user profiles that are non-overlapping are excluded from display at the user interface and from selection for assignment.

14. The apparatus of claim 12, wherein the first set of user profiles are associated with a single-sign-on directory configured for the tenant by an administrator of the parent tenant.

15. The apparatus of claim 12, wherein the first set of user profiles comprises a subset of the second set of user profiles, the subset of the second set of user profiles being assigned to the tenant by an administrator of the parent tenant.

16. The apparatus of claim 12, wherein the instructions to assign the first subset and the second subset are executable by the processor to cause the apparatus to:
assign a first user profile to both the first subtenant and the second subtenant.

17. A non-transitory computer-readable medium storing code, the code comprising instructions executable by a processor to:
receive, at a data management system that is operable to provide protection for data sources associated with one or more tenants of the data management system, an indication to create a set of subtenants of a tenant, a first set of user profiles being associated with the tenant and a second set of user profiles being associated with a parent tenant of the tenant in accordance with metadata corresponding to the first set of user profiles and the second set of user profiles;
assign, in response to receiving the indication, a first subset of the first set of user profiles to a first subtenant of the set of subtenants;
assign, in response to receiving the indication, a second subset of the first set of user profiles to a second subtenant of the set of subtenants, wherein the first subset and the second subset exclude user profiles from the second set of user profiles that are non-overlapping with the first set of user profiles; and
update, in response to assigning the first subset and the second subset, the metadata corresponding to the first set of user profiles and the second set of user profiles such that the first subset has access to the first subtenant for data management of a first data source associated with the first subtenant and the second subset has access to the second subtenant for data management of a second data source associated with the second subtenant.

18. The non-transitory computer-readable medium of claim 17, wherein the instructions are further executable by the processor to:
display, at a user interface of the data management system, the first set of user profiles for selection for assignment to the first subtenant, wherein the second set of user profiles that are non-overlapping are excluded from display at the user interface and from selection for assignment.

19. The non-transitory computer-readable medium of claim 17, wherein the first set of user profiles are associated with a single-sign-on directory configured for the tenant by an administrator of the parent tenant.

20. The non-transitory computer-readable medium of claim 17, wherein the first set of user profiles comprises a subset of the second set of user profiles, the subset of the second set of user profiles being assigned to the tenant by an administrator of the parent tenant.
